(19) United States
(12) Patent Application Publication
(10) Pub. No.: US 2003/0115265 A1
(43) Pub. Date: Jun. 19, 2003

(54) Competition system and method

(75) Inventors: Hironori Kitade, Ishikawa-ken (JP); Seiji Kato, Shiga-ken (JP)

Correspondence Address: F. JASON FAR-HADIAN, Esq., SUITE 420, 1200 PARK NEWPORT DRIVE, NEWPORT BEACH, CA, 92660, US

(73) Assignee: Roundingnet, Ltd.

(21) Appl. No.: 10/319,332

(22) Filed: Dec. 14, 2002

(30) Foreign Application Priority Data
Dec. 18, 2001 (JP) A011218

(51) Int. Cl. G06F 15/16; G06F 19/00; G06F 17/00

(52) U.S. Cl. 709/203; 463/43

(57) ABSTRACT

A method and system for holding a location-independent competition are provided. The method comprises: receiving a plurality of electronic participation images each including a real target; disqualifying a participation image, if the participation image does not include the real target; providing the remaining participation images for viewing; receiving one or more objections associated with one or more participation images; disqualifying a participation image, if the number of objections associated with the participation image has reached a threshold; and determining a winner by evaluating the remaining qualified images based on a first criteria.

### CROSS-REFERENCE TO RELATED APPLICATIONS

Pursuant to 35 U.S.C. § 119(a), this application claims the benefit of earlier filing date and right of priority to the Japanese Application No. A011218, filed on Dec. 18, 2001, the content of which is hereby incorporated by reference herein in its entirety.

### BACKGROUND OF THE INVENTION

1. Field of the Invention

The present invention relates to a system and method for fairly holding a competition, in which a large number of people participate in a wide area, through utilization of a wide-area communication network.

2. Description of the Related Art

Advances in economy and technology in recent years have led to proliferation and development of wide-area communication networks such as the Internet through advances in digital technology. Further individuals have more time for taking interest in various hobbies and leisure activities due to an increase in labor production efficiency and diversification of products and services. The introduction of the Internet has promoted interaction among people and information exchange about various activities such as fishing, for example. A home page on the Internet as a main medium can be used to encourage and facilitate participation.

Moreover, in any field of activity, if an activity is promoted to some extent and the level of the activity is improved, competitions and contests, can be held more often to test the skills of the participants. In addition, supporting companies and other advertiser can use the competitions as valuable opportunities not only for advertisement and promotion but also for acquiring and providing various kinds of information. Thus, some competitions are held utilizing the Internet.

In some competitions, a participant uploads some result of an activity to a predetermined web server on the Internet in the form of an image file taken by a digital camera. The superiority or inferiority of the participant's skills can be decided from the image by a large number of people that can access the uploaded result. For example, in the case of a fishing tournament, a photographed image of a caught fish or a scale for measurement may be uploaded.

Unfortunately, it is difficult to judge whether or not the image uploaded as described above is a genuine image taken on the day of the competition or an illegal image photographed in another opportunity in the past. Therefore, it is difficult to hold a competition fairly. As such, a method and system is needed that can accurately and efficiently verify the uploaded result and enable the participants and voters to fairly provide or select the best results and winners.

### SUMMARY OF THE INVENTION

In accordance with one aspect of the invention, a competition system for holding a competition by exchanging information with client systems via a communication network, comprises: means for accepting registration of a participant for a competition in which the participant participates by sending an image; means for notifying a registered participant of a specific article for certification for inclusion in the image; means for receiving the image from the registered participant; and means for making public a result of the competition based on evaluation of the received image.

In some embodiments the system further comprises means for providing the image for viewing to one or more participants, means for accepting objections for the provided image, and means for disqualification of the image when the number of objections reaches a predetermined threshold. An exemplary embodiment of the competition system relates to a fishing competition, wherein the communication network comprises the Internet.

In accordance with another aspect of the invention, a competition method for holding a competition by exchanging information with client systems via a communication network comprises: accepting registration of a participant for a competition in which the participant participates by sending an image; notifying a registered participant of a specified article for certification that should be included in the image; receiving the image from the registered participant; and making public a result of the competition based on evaluating the received images.

Said method may further comprise the steps of providing the image for viewing, accepting objections associated with the image, and deciding to disqualify the image when the number of objections reaches a predetermined threshold.

In accordance with yet another aspect of the invention, a method for holding a location-independent competition comprises: receiving a plurality of electronic participation images each including a real target; disqualifying a participation image, if the participation image does not include the real target; providing the remaining participation images for viewing; receiving one or more objections associated with one or more participation images; disqualifying a participation image, if the number of objections associated with the participation image has reached a threshold; and determining a winner by evaluating the remaining qualified images based on a first criteria.

In some embodiments, the method further comprises: receiving one or more approvals associated with one or more participation images; and selecting a winner if number of approvals associated with a participation image meets the qualifying criteria.

These and other embodiments of the present invention will also become readily apparent to those skilled in the art from the following detailed description of the embodiments having reference to the attached figures, the invention not being limited to any particular embodiments disclosed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a block diagram illustrating an exemplary communication network configuration of an embodiment of the invention.

### DETAILED DESCRIPTION OF THE PREFERRED EMBODIMENTS

Information management systems and corresponding methods, according to one or more embodiments of the invention, facilitate and provide electronic services for interactive participation of a plurality of competitors regardless of the physical location of the competitors.

To implement one or more embodiments of the invention electronic services in association with an online service provider may be utilized. The terms electronic services and services are used interchangeably through out this patent document. An online service provider provides the services of the system, in one or more embodiments. A service provider is an entity that operates and maintains the computing systems and environment, such as server system and architectures, which process and deliver information. Typically, server architecture includes the infrastructure (e.g., hardware, software, and communication lines) that offers the electronic or online services.

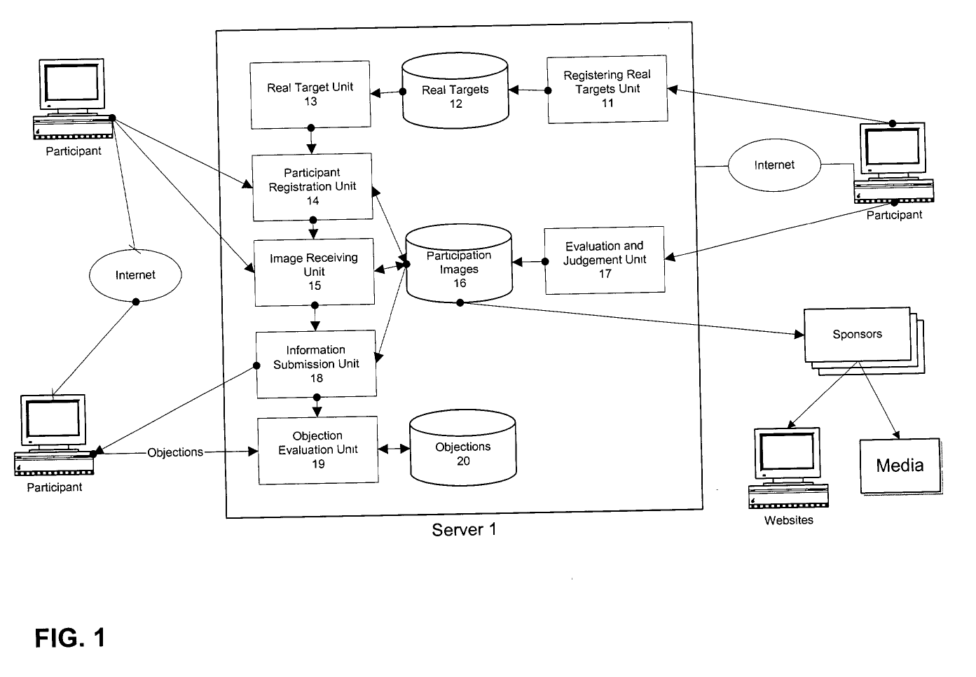

These services provided by the service provider may include telephony and voice services, including plain old telephone service (POTS), digital services, cellular service, wireless service, pager service, voice recognition, and voice user interface. To support the delivery of services, service provider may maintain a system for communicating over a suitable communication network, such as, for example, a communications network illustrated in FIG. 1. Such communications network allows communication via a telecommunications line, such as an analog telephone line, a digital T1 line, a digital T3 line, or an OC3 telephony feed.

In the following, certain embodiments, aspects, advantages, and novel features of the system have been provided. It is to be understood that not all such advantages may be achieved in accordance with any one particular embodiment. Thus, the invention may be embodied or carried out in a manner that achieves or optimizes one advantage or group of advantages as taught herein without necessarily achieving other advantages as may be taught or suggested herein.

The detailed description that follows is presented largely in terms of processes and symbolic representations of operations performed by conventional computers, including computer components. A computer may comprise one or more processors or controllers (i.e., microprocessors or microcontrollers), input and output devices, and memory for storing logic code. The computer may be also equipped with a network communication device suitable for communicating with one or more networks.

The execution of logic code (i.e., computer program) by the processor causes the computer to operate in a specific and predefined manner. The logic code may be implemented as one or more modules in the form of software or hardware components and executed by a processor to perform certain tasks. Thus, a module may comprise, by way of example, of software components, processes, functions, subroutines, procedures, data, and the like.

The logic code conventionally includes instructions and data stored in data structures resident in one or more memory storage devices. Such data structures impose a physical organization upon the collection of data bits stored within computer memory. The instructions and data are programmed as a sequence of computer-executable codes in the form of electrical, magnetic, or optical signals capable of being stored, transferred, or otherwise manipulated by a processor.

It should also be understood that the programs, modules, processes, methods, and the like, described herein are but an exemplary implementation and are not related, or limited, to any particular computer, apparatus, or computer programming language. Rather, various types of general purpose computing machines or devices may be used with logic code implemented in accordance with the teachings provided, herein.

Referring to FIG. 1, a competition system (hereinafter referred to as “the system”) and method in accordance with one aspect of the invention are provided. Certain embodiments of the present invention are realized utilizing physical resources of a computer such as a server where the resources can include hardware or software or a combination of both. Since various forms for realizing hardware and software are possible, the competition system and method by way of example is described as applicable to a virtual circuit diagram corresponding to each function of the present invention as illustrated in FIG. 1. It is noteworthy, however, that the illustrated diagram in FIG. 1 provides an exemplary embodiment of said resources and other functional relationships and components may be utilized to achieve the same result in the manner provided herein, in accordance with other embodiments of the invention.

A First embodiment is a competition system and method for holding a competition by exchanging information with client systems such as personal computers P via the Internet N and is realized by a web server (hereinafter referred to as “the server”) 1. Here, a web site used for holding a competition is referred to as a competition site.

In addition, a competition in this embodiment is a competition in which participants participate by sending photographed images to be posted on the competition site. For the purpose of example, a competition site may be related to a national fishing tournament. Other competition subjects are also possible. Further, in order to prevent illegal acts, a specific article of certification, which is identified to registered participants sometime before a competition is determined.

This article of certification will be required to be included in a submitted image in order to verify that the image was taken sometime during the competition rather than prior to the competition. This specific article of certification is referred to as a real target. An image to be sent in this way is referred to as a participation image. Moreover, in order to realize such a competition, the server 1 can be divided into respective parts shown in FIG. 1. The respective parts are constituted so as to act as described below.

First, guidelines for holding a competition and information on a real target are inputted from a registering real targets unit 11 by an event manager and recorded in a database for real targets 12. Of the information, the guidelines for holding a competition are provided on the competition site beforehand by a real targets unit 13. Registration of participants in the competition is accepted by a participation registration unit 14 and recorded in a database for participation images 16.

During the registration of a participant, a web page, including various user interfaces, such as for example, an input box (e.g., drop-down list, drop box), radio buttons, check boxes, a POST transmission function and the like are used so as to urge the participant to input attribute information such as, for example, a name, an address, a gender, a date of birth, and an electronic mail address at least when the participant registers in the competition for the first time.

In confirming the registration, it is possible to issue an ID and a password and, thereafter, accept an application for participation or the like for each event using the ID and the password, for example. In addition, if a participant is charged for participation, it is possible to sell a participation ticket at a public place (e.g., a store specializing in fishing tackle, or the like) and authenticate a participant through input of an ID and a password shown on the participation ticket.

A registered participant can be notified, via a browser or by way of electronic mail, at a predetermined time before the competition, of the real target. Examples of the real target may include a package of tobacco of a specific brand.

On the date of the competition, each participant may compete (e.g., go fishing) anywhere in a designated competition area. An image receiving unit 15 receives an image in the form of upload from a registered participant and stores the image in the database for participation image 16 in association it with information identifying the participant. In accordance with one aspect of the system, for example, entry of a competition item into the system is possible without an image if a photographic evidence is uploaded to the system within a predetermined amount of time from the date of entry of the competition item (e.g., 24 hours). If the deadline is not met then the participant is disqualified.

An embodiment of the invention, by way of example and for illustration purpose, is discussed as applicable to a fishing tournament. It is to be understood, however, that this invention in other embodiments is applicable to any other competitive sport. In order to secure safety and prevent illegal acts, it is possible to urge each participant to voluntarily designate other one or more participants as accompanying partners. Alternatively, it is also possible to designate accompanying partners from a server side based on a participation area. In these cases, the partners may measure a size of a fish and photograph the fish using a digital camera. In addition, conditions such as taking a photograph of an entire fish and imprinting a face of a person who caught the fish, a real target, and a participation ticket of a currently authenticated participant in an image are presented in guidelines in advance.

After entry of a participation image to the system, the participation image is provided to other participants and general viewing by an information submission unit 18. An objection evaluation unit 19 is provided, in one embodiment of the invention, to accept objections from the participants or the like concerning a participation image in question. For example, in such a case as “this photograph is suspicious to all appearances” or “it is difficult to confirm what is photographed because this picture is out of focus”, a specified number of votes of “nonconfidence” are allowed with respect to one participant. When the number of objections has reached a predetermined criterion (e.g., 10% of the number of participants, etc.), the objection evaluation unit 19 can decide to disqualify the participant.

Participants with excellent performances may be provided with prizes such as commendation, awards, prize money and points, and images and results of a competition of the participants are made public on a competition site through the information submission unit 18. In addition, the images and results are shown and reported on a magazine such as a magazine specializing in fishing. Prize winners can be selected based on automatic counting performed by the system. However, for example, concerning images, an event manger may perform confirmation, evaluation and judgment on whether numbers and images are correct, by using the evaluation and judgment unit 17.

The criteria for superiority or inferiority of participants can be set based on various standards. As an example, participants performances may be evaluated based on a number found by adding or subtracting a certain size of a round number to or from an average size of a fish whose images are sent. Participants may be also evaluated strictly based on the size of the fish caught. Moreover, it is also possible to count performances of events annually and invite participants who have satisfied a predetermined criterion to a final contest, for example.

Accordingly, the present invention make it possible to fairly hold a competition such as a fishing tournament, in which a large number of people can participate regardless of the location of their residence, through utilization of a wide-area communication network, such as the Internet.

The embodiments described above are to be considered in all aspects as illustrative only and not restrictive in any manner. Thus, other exemplary embodiments, system architectures, platforms, and implementations that can support various aspects of the invention may be utilized without departing from the essential characteristics described herein. For example, certain embodiments of the invention may be utilized for competitions for best picture in a certain category (e.g., nature, animals, scenery, etc.) These and various other adaptations and combinations of features of the embodiments disclosed are within the scope of the invention. The invention is defined by the claims and their full scope of equivalents.

What is claimed is:

1. A competition system for holding a competition by exchanging information with client systems via a communication network, comprising:
means for accepting registration of a participant for a competition in which the participant participates by sending an image;
means for notifying a registered participant of a specific article for certification for inclusion in the image;
means for receiving the image from the registered participant; and
means for making public a result of the competition based on evaluation of the received image.

2. A competition system according to claim 1, further comprising:
means for providing the image for viewing to one or more participants,
means for accepting objections for the provided image, and
means for disqualification of the image when the number of objections reaches a predetermined threshold.

3. A competition system according to claim 1, wherein the competition relates to fishing.

4. A competition system according to any one of claims 1, wherein the communication network comprises the Internet.

5. A competition method for holding a competition by exchanging information with client systems via a communication network, comprising:
accepting registration of a participant for a competition in which the participant participates by sending an image;
notifying a registered participant of a specified article for certification for inclusion in the image;
receiving the image from the registered participant; and
making public a result of the competition based on evaluating the received images.

6. A competition method according to claim 5, further comprising:
providing the image for viewing,
accepting objections associated with the image, and
disqualifying the image when the number of objections reaches a predetermined threshold.

7. A competition method according to claim 5, wherein the competition relates to fishing.

8. A competition method according to any one of claims 5, wherein the communication network includes the Internet.

9. A method for holding a location-independent competition comprising:
receiving a plurality of electronic participation images each including a real target;
disqualifying a participation image, if the participation image does not include the real target;
providing the remaining participation images for viewing;
receiving one or more objections associated with one or more participation images;
disqualifying a participation image, if the number of objections associated with the participation image has reached a threshold; and
determining a winner by evaluating the remaining qualified images based on a first criteria.

10. The method of claim 9, further comprising:
receiving one or more approvals associated with one or more participation images; and
selecting a winner if number of approvals associated with a participation image meets the qualifying criteria.
